(19) United States
(12) Patent Application Publication
(10) Pub. No.: US 2024/0270635 A1
(43) Pub. Date: Aug. 15, 2024

(54) METHOD FOR OBTAINING GLAZINGS EQUIPPED WITH AN ENAMEL COATING AND ELECTRICALLY CONDUCTIVE DESIGNS

(71) Applicant: SAINT-GOBAIN GLASS FRANCE, COURBEVOIE (FR)

(72) Inventors: Alexia YON, CHANTILLY (FR); Jalal BACHAROUCHE, CLAIROIX (FR)

(21) Appl. No.: 18/255,981

(22) PCT Filed: Dec. 6, 2021
(86) PCT No.: PCT/FR2021/052217

§ 371 Date: Jun. 5, 2023

(30) Foreign Application Priority Data
Dec. 7, 2020 (FR) FR2012762

(51) Int. Cl. C03C 17/36; B60J 1/18; C03C 17/00

(52) U.S. Cl. CPC C03C 17/3681; B60J 1/18; C03C 17/002; C03C 17/3607; C03C 17/3644; C03C 17/3655; C03C 17/3673; C03C 2218/119; C03C 2218/32

(57) ABSTRACT

A method for obtaining a glazing includes depositing, by an inkjet printing technique, an enamel coating on part of a face of a glass sheet, then depositing, at least on part of the enamel coating, an electrically conductive layer forming designs, then performing a heat treatment for curing the enamel coating and the electrically conductive layer, the thickness of the designs formed by the electrically conductive layer being at least 3 μm after the curing heat treatment.

The present invention relates to the field of printing enamel and electrically conductive designs on glazing.

Electrically conductive designs, such as heating wires, bus bars, antennae or other sensors present in motor vehicle glazing are made from a conductive paste, for example a silver paste screen-printed onto a glass sheet, and are connected to a power supply system via connectors soldered to the conductive paste. The connectors are soldered in certain well-defined zones of the glazing, referred to as soldering zones, and the alloys currently used to produce these solders are lead-free alloys, for example based on silver, tin and copper.

A black enamel coating is generally deposited by screen-printing at the periphery of the glass sheet, and part of the electrically conductive designs (particularly the bus bars) is then deposited on the enamel coating. Such a coating makes it possible to conceal the seals serving for positioning and mounting the glazing in the window opening of a vehicle body, and to protect them from ultraviolet radiation. The enamel coating also makes it possible to conceal the bus bars.

Glazing equipped with such electrically conductive designs must, in order to be put on the market and accepted by motor vehicle manufacturers, successfully pass increasingly stringent resistance tests. The alloys used for the solders must particularly meet the criteria required by the TCT (or “temperature cycling test”) test. The aim of this test is to determine if, once it is equipped with electrical functions, the glazing can withstand successive and rapid temperature rises and drops without becoming brittle. These tests have been developed in order to accelerate the effects which would be caused by the differences in thermal behavior of the various components of the system. The new test imposes temperature variations between −40° C. and +105° C., therefore over a greater range of variation than previous tests which stopped at 90° C. The number of cycles has also been changed, increasing from 10 cycles to a minimum of 60 cycles. The new conditions of the TCT also require these temperature variations to be carried out under a voltage of 14 V during the temperature rise phases, which leads to additional heating and corresponds to local temperature which may extend approximately up to 120° C.

The aim of the invention is to improve the mechanical strength of a glazing equipped with enamel, electrically conductive designs and a connector soldered using a soldering alloy.

To this end, the subject matter of the invention is a method for obtaining a glazing comprising the following steps:
depositing, by an inkjet printing technique, an enamel coating on part of a face of a glass sheet, then
depositing, at least on part of the enamel coating, an electrically conductive layer forming designs, then
a step of heat treatment for curing the enamel coating and the electrically conductive layer, the thickness of said designs being at least 3 μm after the curing heat treatment step.

Another subject matter of the invention is a glazing obtained or capable of being obtained by this method. This glazing comprises a glass sheet coated on part of one of the faces thereof with an enamel coating deposited by an inkjet printing technique, an electrically conductive layer forming designs, the thickness of which is at least 3 μm, being deposited at least on part of said enamel coating.

The glass sheet is typically made of soda-lime-silica glass, but may be made of other types of glass, for example borosilicate or aluminosilicate. The thickness thereof is preferably between 0.7 and 6 mm, particularly between 1 and 4 mm. At least one dimension of the glass sheet is preferably at least 1 m.

The glass sheet may be clear, or, preferably tinted, for example in green, gray or blue. To achieve this, the composition of the glass comprises colorants, in particular iron oxide, in a total weight content (expressed in the form Fe₂O₃) between 0.05 and 1.5%, in particular between 0.1 and 1.0%.

The glass sheet is generally flat when the enamel coating and the electrically conductive designs are deposited. It is subsequently preferably bent, usually during the heat treatment for curing the electrically conductive designs and the enamel. Preferably, then, the finished glazing will be bent.

Surprisingly, it has been found that depositing the enamel coating by inkjet printing made it possible to obtain better mechanical strengths at the soldering zone than using the customary screen printing technique.

The inkjet printing is preferably carried out using a printhead, the movement of which (in particular the position and the speed) is computer controlled, or using a series of stationary printheads, which the glass faces and passes by at a controlled speed.

To this end, the or each printhead comprises nozzles through which drops of ink are projected locally onto the glass sheet. This technique is sometimes called “drop on demand” (DOD).

The enamel coating is preferably deposited using an ink comprising a glass frit, pigments, solvents and an organic binder.

The glass frit is preferably based on bismuth borosilicate and optionally on zinc borosilicate. The pigments preferably comprise one or more oxides selected from oxides of chromium, copper, iron, manganese, cobalt, nickel. These may be, by way of example, copper and/or iron chromates.

Advantageously, the glass frit and the pigments have a particle size distribution by volume such that the D90 is at most 2 μm. The D90 is for example determined by laser particle size analysis.

The viscosity of the ink is preferably between 1 and 50 mPa·s.

The thickness of the enamel coating after curing is preferably between 2 and 15 μm, particularly between 3 and 8 μm.

The enamel coating is preferably opaque. It is generally black, but other colors are possible. The coating preferably forms a strip at the periphery of the glazing. This strip may include designs such as shaded dots or any other decorative design. The coating may also include openings such as transmission windows for sensors and cameras, in zones referred to as camera zones which may be located in more central parts of the glazing (for example at the interior rear view mirror in the case of a windscreen). The black hue is preferably such that the value of L* in reflection on the glass side (illuminant D65, 10° reference observer) is less than 10, particularly than 5 and even than 3. The opaqueness is preferably such that the optical density of the coating is at least 3.

An electrically conductive layer forming designs is deposited at least on part of the enamel coating.

As explained hereinafter, part of the designs may also be deposited outside of the enamel coating, i.e. commonly on naked glass.

The electrically conductive designs preferably comprise electrically conductive tracks located in at least one lateral part and in a central part of the glazing.

The electrically conductive tracks located in the central part are particularly heating wires, alarm wires and/or antennas. Some of these tracks, in particular the heating wires, are deposited on naked glass and not on the enamel coating. The electrically conductive tracks located in a lateral part, particularly in two opposite lateral parts, are particularly bus bars. These tracks are generally deposited on the enamel coating.

Advantageously, the electrically conductive layer encompasses at least one soldering zone, the method further comprising an additional step of soldering at least one connector to at least part of at least one soldering zone using a soldering alloy. This soldering zone is preferably arranged in a part of the electrically conductive layer which is deposited on the enamel coating.

These are for example soldering zones for connecting antennas or alarms, which are more located in the central part, and/or soldering zones for connecting a heating network, which are located in the lateral parts. The latter are for example located on each of the bus bars.

The soldering zones are zones onto which a connector can be soldered in order to electrically connect the electrically conductive designs. The method may therefore also comprise an additional step of soldering at least one connector to at least part of a soldering zone. The soldering is in particular carried out using a soldering alloy.

The connector is typically metallic, particularly made of steel containing chromium. The soldering alloy is preferably lead-free, particularly based on tin, silver and optionally copper. The soldering alloy preferably comprises from 90 to 99.5% by weight of tin, from 0.5 and 5% by weight of silver and from 0 to 5% by weight of copper.

The electrically conductive layer forming designs is preferably deposited by screen printing or by a digital printing technique.

The screen printing step is preferably carried out by positioning a screen printing screen facing the glass sheet, then by depositing, particularly using a doctor blade, an electrically conductive paste, particularly containing silver, on the screen printing screen. The apertures of the screen are blocked off in the part corresponding to the zones of the glass sheet which are not to be coated, such that the paste can only pass through the screen in the zones to be printed, according to a predefined design.

The electrically conductive designs are preferably formed from a silver paste.

Preferably, the silver electrically conductive paste, in its wet state, comprises at most 88%, particularly at most 85% by weight of silver, for example 75% to 85%, particularly 80 to 84% by weight of silver. These pastes containing a high silver content compared to the pastes customarily used are particularly well-suited to lead-free soldering alloys. In order to ensure good solderability and good resistance in the TCT test, these silver pastes may require the application of greater thicknesses in the soldering zones.

The lower the silver content of the paste, the thicker the designs in the wet state (before curing) must be for the same thickness of the design after curing. Thus, for a design thickness of 8 μm after curing, the thickness in the wet state is typically of the order of 25 μm for a paste containing 80% by weight of silver, and of the order of 35 to 40 μm for a paste containing 75% by weight of silver.

Preferably, the paste further comprises a solvent, an organic medium, intended to facilitate the depositing by screenprinting, and a glass frit, which after fusion, attaches the silver particles to the glass sheet.

The screen may be made of any material known for producing screen printing screens, for example polyester or polyamide.

The screen is preferably obtained by coating a photocrosslinkable emulsion on at least part of the surface of the screen, exposing the screen to light in order to crosslink the photocrosslinkable emulsion in predetermined zones, then washing and drying the screen. The photocrosslinkable emulsion makes it possible to selectively block off the apertures of the screen in the zones exposed to light, with the washing step serving particularly to eliminate the emulsion from the zones not exposed to light, i.e. in the parts in which the apertures must remain open and through which the printing paste must pass during the screen printing and coat the glass sheet in order to form the electrically conductive designs. The step of exposure to light is the step during which the emulsion photocrosslinks, generally under the effect of ultraviolet radiation. This step is typically carried out by arranging a slide comprising a transparent support, typically made of polyester, coated with designs of an ink which is opaque to ultraviolet radiation, corresponding to the electrically conductive designs to be printed on the glazing, then by irradiating said slide by means of ultraviolet radiation. The emulsion is therefore only crosslinked, and only blocks off the apertures of the screen, in the parts of the screen located under the parts of the slide which are not covered with ink. In the other parts, the emulsion is not crosslinked and is eliminated during the washing step, leaving open apertures such that the paste can pass through them during the screen printing. Thus, identical designs are found on the glazing as those found on the slide.

According to an embodiment, the aperture size of the screenprint screen is identical at all points. The thickness of the electrically conductive layer is then identical at every point of the glazing.

For example, for the screen, 90 threads per cm can be chosen for thread diameters from 40 to 48 μm.

The wet thickness of the electrically conductive layer is then preferably between 25 and 30 μm, giving thicknesses after curing of the order of 8 μm for silver pastes containing 80% by weight of silver.

According to another embodiment, the screen printing screen comprises a central part and at least one lateral part, the aperture size in the central part being larger than the aperture size in at least one lateral part. In particular, the number of threads per cm in the central part is greater than the number of threads per cm in the at least one lateral part, and the diameter of the threads in the central part is less than the diameter of the threads in the at least one lateral part.

In the context of this embodiment, it is advantageously possible to select:
in the central portion, 77 threads per cm for a diameter of 48 μm, 77 threads per cm for a diameter of 55 μm, 90 threads per cm for a diameter of 48 μm,
in the, or each, lateral portion, 42 threads per cm for a diameter of 80 μm, 48 threads per cm for a diameter of 80 μm, 49 threads per cm for a diameter of 70 μm.

This type of screen makes it possible particularly to deposit a greater thickness of electrically conductive paste at the lateral parts, which correspond to the positioning of the bus bars, compared to the printing zones corresponding to the thinner wires of the heating network. Mention may be made, as examples of this type of screen, of the product Vario® by SEFAR or Variant® by SAATI, which make it possible, during the same printing operation, to obtain different thicknesses in different zones of the glazing.

The screen is preferably rectangular or substantially rectangular, and the central part corresponds to the rectangular part, extending over the whole length of the short sides of the screen, for which the perpendicular bisector of the short sides corresponds to the perpendicular bisector of the long sides of the screen, and which occupies 20 to 40% of the surface of the screen. The screen preferably comprises two lateral parts, corresponding to the two rectangular parts arranged symmetrically with respect to the perpendicular bisector of the long sides of the rectangle, on both sides of the latter, occupying from 20 to 40% of the surface of the screen.

The thickness of the electrically conductive designs is at least 3 μm, preferably between 8 and 20 μm, or even between 10 and 15 μm after the curing heat treatment step.

The glazing may or may not be dried after the paste is applied. The glazing subsequently undergoes a heat treatment in order to cure the enamel coating and the electrically conductive layer. This heat treatment is typically a glass bending and/or tempering treatment. Bending can be carried out using gravity, for example (the glass deforms under its own weight) or through pressing, at temperatures typically ranging from 550 to 720° C.

The finished glazing is particularly a motor vehicle rear window, a motor vehicle side glazing, a motor vehicle roof or else a motor vehicle windscreen.

The electrically conductive designs are particularly antennas, bus bars, alarm wires and/or heating wires. The bus bars are preferably located in the two opposite lateral parts of the glazing. The heating wires are preferably predominantly located in the central part of the glazing, and extend parallel to the long edge of the glazing between the two bus bars. This is particularly the case for a rear window.

Preferably, the or each soldering zone is a soldering zone for connecting antennas and/or heating networks and/or alarms.

In the case of a windscreen, the electrically conductive designs are particularly antennas.

The electrically conductive designs may also be heating wires, providing local heating in the camera zones, for example for detecting the distance from the vehicle in front.

In the case of a side glazing, the electrically conductive designs are particularly antennas or alarm wires.

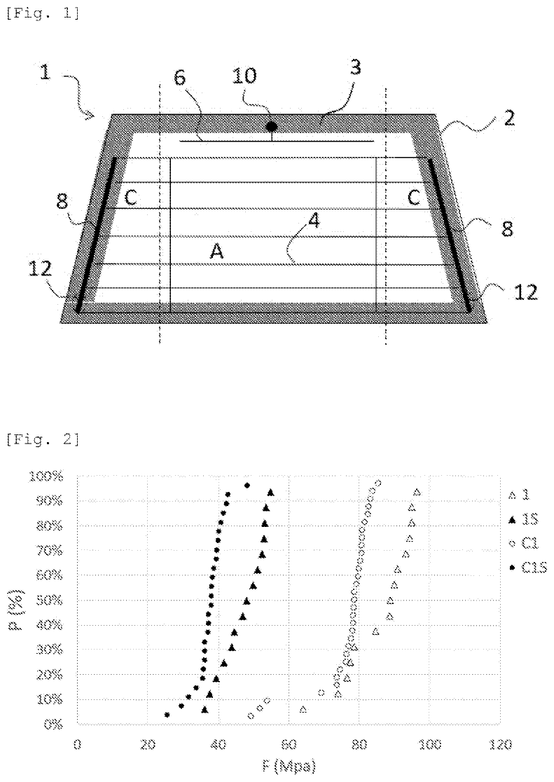

The invention will be better understood in light of the following exemplary embodiments, illustrated by FIGS. 1 and 2.

FIG. 1 shows a glazing obtained according to the invention, in the example a motor vehicle rear window.

FIG. 2 shows 3-point bending mechanical strength curves.

As shown in FIG. 1, the glazing 1 comprises a glass sheet 2 having a central part A and two lateral parts C. In these parts A and C, electrically conductive designs 4, 6, 8, 10 have been printed, more specifically a network of horizontal and vertical heating wires 4, connected in the lateral parts C to bus bars 8, an antenna 6, a soldering zone for antenna fitting 10. In each lateral part C, the bus bars 8 comprise a soldering zone 12 for supplying the heating network. The position of the soldering zones 12, here in the lower part of the bus bars 8, is schematically shown on the figure by dashed lines.

The wires 4, 6 and bus bars 8, and also the antenna fitting 10, are for example printed by screen printing a silver paste (comprising 80% by weight of silver).

Some of these designs are deposited on an enamel coating 3 forming, after curing, a black and opaque peripheral strip.

The mechanical strength of the glazings was evaluated as follows.

An electrically conductive layer was deposited on an enamel coating, which was itself deposited on a glass sheet.

In a comparative example, the enamel was deposited by screen printing an enamel composition (Ferro 14501) comprising a glass frit (D90=6.5 μm), pigments (D90=6.5 μm), an organic binder and a solvent. The viscosity was 14 Pa·s. The wet thickness was 20 μm.

In an example according to the invention, the enamel was deposited by inkjet at a temperature of 40° C., the ink (Tecglass 1A019) comprising a glass frit (D90<2 μm), pigments (D90<2 μm), an organic binder, a solvent and additives. The viscosity was a few tens of mPa·s and the thickness deposited was 5 μm.

The silver paste was subsequently deposited by screen printing a silver paste composition (Ferro SP1989—80%), comprising a glass frit and particles of silver metal (D(90)=6.1 microns). The viscosity was 27 Pa·s. The wet thickness deposited was 25 μm.

The glass sheet subsequently underwent a heat treatment at a temperature of approximately 650° C., during which step the curing of the enamel coating and of the electrically conductive layer was also carried out.

An alloy comprising (by weight) 96.5% tin, 3% silver and 0.5% copper was subsequently deposited on the silver paste. This alloy serves to solder connectors using a soldering iron, between 400° C. and 450° C.

The samples (without connectors) subsequently underwent mechanical strength tests. To this end, 15 samples of each example underwent a 3-point bending strength test.

FIG. 2 shows the probability of breaking (denoted P) based on the force applied (denoted F and expressed in MPa).

Examples 1 and 1S correspond to the example according to the invention, respectively without and with the soldering alloy. Examples C1 and C1S correspond to the comparative example, respectively without and with the soldering alloy.

The results show that depositing the soldering alloy embrittles the glazing. Nevertheless, whether in the absence or presence of the soldering alloy, the use of an inkjet printing deposition technique for depositing the enamel makes it possible to improve the mechanical strength compared to the use of screen printing.

1. A method for obtaining a glazing, comprising:
depositing, by an inkjet printing technique, an enamel coating on part of a face of a glass sheet, then
depositing, at least on part of the enamel coating, an electrically conductive layer forming designs, then
a step of heat treatment for curing the enamel coating and the electrically conductive layer, a thickness of designs formed by the electrically conductive layer being at least 3 μm after the curing heat treatment step.

2. The method according to claim 1, wherein the enamel coating is deposited using an ink comprising a glass frit, pigments, solvents and an organic binder.

3. The method according to claim 2, wherein the glass frit and the pigments have a particle size distribution by volume such that the D90 is at most 2 μm.

4. The method according to claim 2, wherein a viscosity of the ink is between 1 and 50 mPa·s.

5. The method according to claim 1, wherein a thickness of the enamel coating after curing is between 2 and 15 μm.

6. The method according to claim 1, wherein the enamel coating is opaque, black, and forms a strip at the periphery of the glazing.

7. The method according to claim 1, wherein the designs comprise electrically conductive tracks located in at least one lateral part and in a central part of the glazing.

8. The method according to claim 1, wherein the designs are formed from a silver paste comprising, in a wet state, at most 88% by weight of silver.

9. The method according to claim 8, wherein the silver paste comprises, in the wet state, from 75 to 85% by weight of silver.

10. The method according to claim 1, wherein the electrically conductive layer forming designs is deposited by screen printing or by a digital printing technique.

11. The method according to claim 1, wherein the electrically conductive layer encompasses at least one soldersoldering zone, the method further comprising an additional step of soldersoldering at least one connector to at least part of at least one soldersoldering zone using a soldersoldering alloy.

12. The method according to claim 11, wherein the at least one connector is made of steel containing chromium.

13. The method according to claim 11, wherein the soldersoldering alloy is lead-free, based on tin, silver and optionally copper.

14. A glazing obtained by the method according to claim 1, comprising a glass sheet having a face coated on part thereof with an enamel coating deposited by an inkjet printing technique, an electrically conductive layer forming designs having a thickness that is at least 3 μm, and deposited at least on part of said enamel coating.

15. The glazing according to claim 14, which is a motor vehicle rear window, a motor vehicle side glazing, a motor vehicle roof or a motor vehicle windscreen.

16. The method according to claim 5, wherein the thickness of the enamel coating after curing is between 2 and 15 μm.

17. The glazing according to claim 15, wherein designs form antennas, bus bars, alarm wires and/or heating wires, the designs comprising a soldersoldering zone for connecting the antenna and/or heating network and/or alarm.
